(19) United States
(12) Patent Application Publication
(10) Pub. No.: US 2016/0325643 A1
(43) Pub. Date: Nov. 10, 2016

(54) VEHICLE SEAT HAVING A DRIVING DEVICE AND A METHOD FOR ATTACHING A DRIVING DEVICE IN A PLAY-FREE MANNER

(71) Applicant: JOHNSON CONTROLS GMBH, Burscheid (DE)

(72) Inventors: Thorsten KLEIN-HITPASS, Koeln (DE); Hilmar WAHLEN, Hueckeswagen (DE); Ulli GENUTT, Much (DE)

(21) Appl. No.: 15/109,901

(22) PCT Filed: Jan. 5, 2015
(86) PCT No.: PCT/EP2015/050021

§ 371 Date: Jul. 6, 2016

(30) Foreign Application Priority Data
Jan. 7, 2014 (DE) 10 2014 200 028.9
Apr. 22, 2014 (DE) 10 2014 207 529.7

(51) Int. Cl. B60N 2/16; F16H 57/12; F16H 19/04; B60N 2/44

(52) U.S. Cl. CPC B60N 2/165; B60N 2/4435; B60N 2/443; F16H 57/12; F16H 19/04; B60N 2205/20

(57) ABSTRACT

A vehicle seat (1) has a driving device (20), including a pinion (25) in tooth engagement with a set of teeth (95) of an adjustment system, is fastened to a structural part (100) of the vehicle seat (1). At least one spring element (110) applies a force to the driving device (20) in the direction of the tooth engagement. A method for play-free attaching a driving device (20) to a structural part (100) of a vehicle seat (1) provides the driving device (20) as a drive of a height adjustment kinematic system (5). A force is applied to the driving device (20) in a direction of the tooth engagement by at least one spring element (110) such that a possible play between the pinion (25) and the set of teeth (95) is eliminated. The position of the driving device (20) in relation to the structural part (100) is secured.

### CROSS REFERENCE TO RELATED APPLICATIONS

This application is a United States National Phase Application of International Application PCT/EP2015/050021 filed Jan. 5, 2015 and claims the benefit of priority under 35 U.S.C. §119 of German Applications 10 2014 200 028.9 filed Jan. 7, 2014 and 10 2014 207 529.7 filed Apr. 22, 2014, the entire contents of which are incorporated herein by reference.

### FIELD OF THE INVENTION

The invention relates to a vehicle seat having a drive device which comprises a pinion which is in toothed engagement with a tooth arrangement of an adjustment kinematic of the vehicle seat, wherein the drive device is secured to a structural component of the vehicle seat. The invention further relates to a method for play-free connection of a drive device to a structural component of a vehicle seat, wherein the drive device comprises a pinion which is in toothed engagement with a tooth arrangement of an adjustment kinematic, in particular a height adjustment kinematic, of the vehicle seat.

### BACKGROUND OF THE INVENTION

Both for vehicle seat height adjusters and for backrest adjusters, drive devices for operating or adjusting the seat function are known. These are often electric drives or mechanical bidirectional step-by-step switching systems whose actuation angle is generally from 15 to 30° and which transmit only the respective actuation direction and which are decoupled on the return path from the output. Such mechanisms are conventional as load-absorbing systems in height adjusters. When used as backrest adjusters, the driven backrest fitting which is constructed as a gear fitting generally absorbs the working and crash loads. Known drive devices are disclosed, for example, in DE 19709852 A1 and DE 19540631 A1.

A drive device which is known through use comprises a pinion which is in toothed engagement with a tooth arrangement of a height adjustment kinematic of the vehicle seat, wherein the drive device is secured to a structural component of the vehicle seat. During assembly of the drive device, it is pressed by the fitter in the direction of the toothed engagement and first retained manually in this position. The fitter can release the drive device again only when he has secured the position of the drive device relative to the structural component by means of a plurality of screws. In the event of negligence during the assembly operation, the position of the drive device can be displaced again before the screws are completely tightened.

Individual component tolerances and occurrences of assembly imprecision result in the risk of an incorrect position of the tooth arrangements of the pinion and height adjustment kinematic with respect to each other. If the tooth arrangements are located too close to each other, the assembly is made more difficult. Play between the tooth arrangements can in contrast lead to noises and reduces the forces which can be transmitted via the tooth engagement location.

### SUMMARY OF THE INVENTION

An object of the invention is to provide a vehicle seat having a drive device which can be assembled in a simple and cost-effective manner and which additionally has a low-play or play-free toothed engagement between a pinion and a drive device and a tooth arrangement of an adjustment kinematic, in particular a height adjustment kinematic, of the vehicle seat.

An object of the invention is further to provide a method for play-free connection of a drive device to a structural component of a vehicle seat and consequently to provide a vehicle seat according to the invention.

This object is achieved according to the invention by a vehicle seat having a drive device which comprises a pinion which is in toothed engagement with a tooth arrangement of an adjustment kinematic of the vehicle seat, wherein the drive device is secured to a structural component of the vehicle seat, wherein at least one resilient means acts on the drive device in the direction of the toothed engagement with a force.

As a result of the fact that at least one resilient means acts on the drive device in the direction of the toothed engagement with a force, during the assembly of the vehicle seat any play which is present between the pinion of the drive device and the tooth arrangement of the adjustment kinematic is automatically eliminated. In addition, the pinion is always acted on with a defined force during the assembly so that an excessively high force between the pinion and tooth arrangement is prevented.

The adjustment kinematic may be a height adjustment kinematic of the vehicle seat. By means of the height adjustment kinematic, the height of a seat cushion of the vehicle seat or the height of the overall vehicle seat in the vehicle can be changed.

Preferably, the at least one resilient means is secured, in particular directly, to the structural component. The structural component to which the resilient means is secured may be the same structural component to which the drive device is secured.

The resilient means is advantageously constructed integrally with the structural component, for example, formed with the structural component from sheet metal, preferably sheet steel. Sheet steel alloys which are conventionally used in vehicle seats have a sufficient degree of resilience to be able to form a resilient means.

At least the resilient means is preferably constructed from sheet metal, preferably sheet steel. The structural component may, however, also be constructed from another material, for example, a fiber-reinforced plastics material. The resilient element may then be introduced as an insertion component into the fiber-reinforced plastics material and partially protrude therefrom.

The at least one resilient means acts with a resultant resilient force preferably on a housing of the drive device. The resultant resilient force preferably acts in the direction of the tooth arrangement. At least one component of the resultant resilient force acts in the direction of the tooth arrangement. Preferably, the component which is orientated in the direction of the tooth arrangement acts on the housing of the drive device.

Preferably, precisely two resilient means act on the drive device. The drive device is thereby fixed in a statically determined manner between the two resilient means and the toothed engagement before being secured to the structural component in the manner of a tripod. The resultant resilient force preferably acts in the direction of the tooth arrangement. At least one component of the resultant resilient force acts in the direction of the tooth arrangement.

In a preferred embodiment, the vehicle seat according to the invention has for connection of the drive device a structural component which is constructed as a seat frame side portion of a seat frame of the vehicle seat. The seat frame may have two seat frame side portions and two transverse pipes which connect them together. The drive device may serve to drive a height adjustment kinematic of the vehicle seat.

The drive device may comprise a housing. A portion of this housing may extend through an opening in the structural component. Preferably, the dimensions of the opening and the portion of the housing which extends through the opening are adapted to each other in such a manner that the drive device can be moved slightly in the direction of the toothed engagement before it is fixed to the structural component. For example, the portion of the housing which extends through the opening in the structural component may be constructed to be circular with a first diameter and the opening in the structural component may also be constructed to be substantially circular with a second diameter, wherein the second diameter is slightly larger than the first diameter. The diameter difference between the first diameter and the second diameter is then preferably twice as large as the tolerances which are intended to be compensated for in order to ensure an optimum toothed engagement between the pinion and the tooth arrangement of the adjustment kinematic.

Preferably, the at least one resilient means may be constructed as a flap which extends from an edge region of the opening in the direction of the center of the opening. The flap may be in abutment with the housing and may act on it with a force. A resultant force advantageously acts in the direction of the toothed engagement. This can be achieved, for example, by there being provided precisely one flap which acts in the direction of the toothed engagement, or there being provided precisely two flaps which produce a resultant force in the direction of the toothed engagement. However, it is sufficient for at least one flap, or more generally a resilient means, to apply a force to the drive device and for this force to have a force component in the direction of the toothed engagement.

The object is further achieved according to the invention by a method for play-free connection of a drive device to a structural component of a vehicle seat, wherein the drive device comprises a pinion which is in toothed engagement with a tooth arrangement of an adjustment kinematic, in particular a height adjustment kinematic, of the vehicle seat, wherein the drive device is acted on with a force by means of at least one resilient means in the direction of the toothed engagement in such a manner that any potential play between the pinion and the tooth arrangement is eliminated and in another method step the position of the drive device relative to the structural component is secured. Preferably, the securing is carried out by means of a screw connection, in particular with three screws.

The vehicle seat according to the invention and the method according to the invention bring about an automatic play compensation by the pinion and the (counter) tooth arrangement always being positioned with the correct spacing with respect to each other.

The number of resilient means is in principle not limited. However, for reasons of structural space and cost, a number of one or two resilient means is preferred.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of the vehicle seat;

FIG. 2 is a perspective detailed view of a vehicle seat known from the prior art, wherein a drive device of the vehicle seat is illustrated in the manner of an exploded view offset with respect to the remainder of the vehicle seat;

FIG. 3 is a side view of a seat frame side portion of the vehicle seat known from the prior art from FIG. 2;

FIG. 4 is a side view from the viewing direction of the seat center of a portion of a height adjustment kinematic of the vehicle seat from FIG. 2;

FIG. 5 is a view corresponding to FIG. 2 according to a first embodiment of a vehicle seat according to the invention;

FIG. 6 is a perspective view showing a seat frame side portion of the vehicle seat from FIG. 5;

FIG. 7 is a view of a portion of the height adjustment kinematic according to the first embodiment;

FIG. 8 is a perspective view showing a seat frame side portion according to a second embodiment of a vehicle seat according to the invention; and

FIG. 9 is a view corresponding to FIG. 7 of the second embodiment.

### DESCRIPTION OF THE PREFERRED EMBODIMENTS

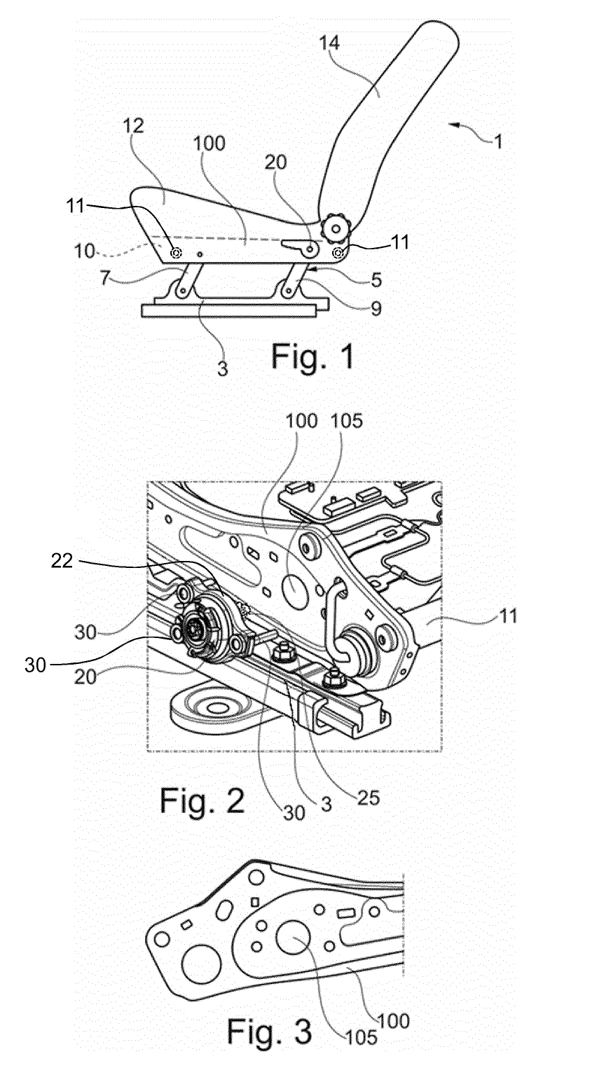

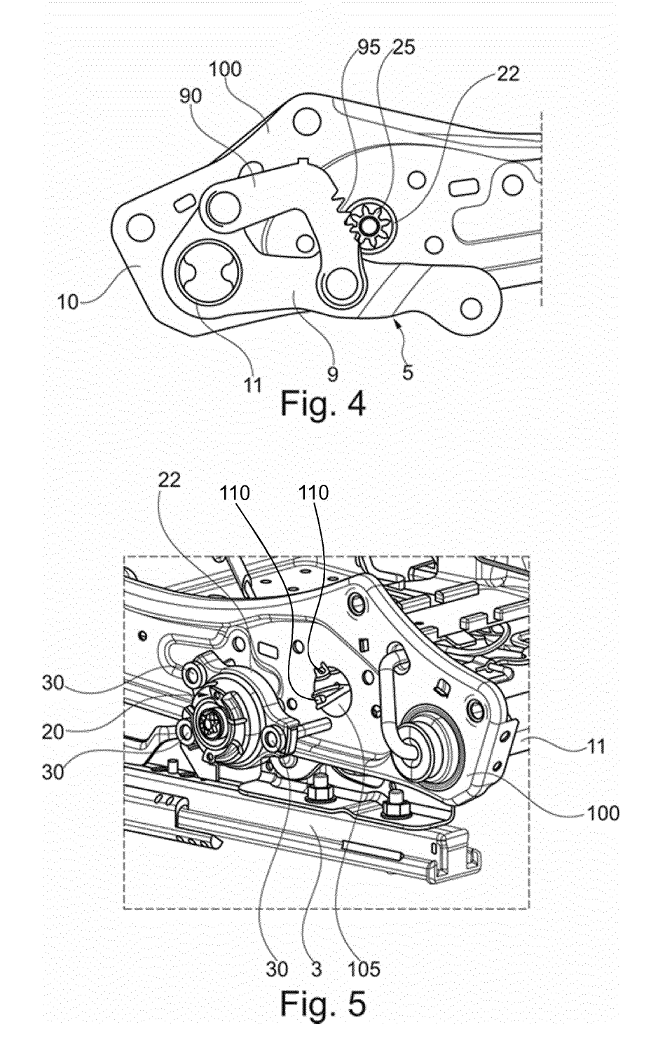

Referring to the drawings, in FIGS. 1 to 4, a vehicle seat 1 known from the prior art is described below. The vehicle seat 1 for a motor vehicle is secured with a base 3, for example, two seat rail pairs, to the vehicle base of the motor vehicle. A height adjustment kinematic 5 of the vehicle seat 1 has at each of the two vehicle seat sides a four-bar arrangement which is formed by the base 3, a front rocker arm 7, a rear rocker arm 9 and a seat frame side portion 100 of a seat frame 10 which are each connected to each other by means of rotary joints.

The seat frame 10 comprises in a manner known per se at each of the two vehicle seat sides a seat frame side portion 100, respectively. The two seat frame side portions 100 are connected to each other by means of two transverse pipes 11 which extend substantially perpendicularly to the extent of the seat frame side portions 100.

The seat frame 10 carries a seat cushion 12 and in this instance also a backrest 14. By means of the height adjustment kinematic 5, the height of the seat cushion 12 and in this instance at the same time the backrest 14 of the vehicle seat 1 can be adjusted by means of the vehicle base (and consequently via the base 3).

In order to drive and lock the height adjustment kinematic 5, there is provided at least one drive device 20 which acts on a vehicle seat side between two gear members of the four-bar linkage at that location, in this instance between one of the two seat frame side portions 100 and a tooth segment 90 which is securely connected to one of the two rear rocker arms 9.

The tooth segment 90 is in this instance an L-shaped sheet metal member with two members which together define an angle of substantially 90°. The two ends of the members which face away from each other are securely connected to one of the two rear rocker arms 9, in this instance riveted. One of the two members of the tooth segment 90 has a tooth arrangement 95. The member which has the tooth arrangement 95 is curved about the articulation location between the rear rocker arm 9 and the seat frame side portion 100 so that the tooth arrangement 95 is also constructed accordingly in a curved, in this instance convex, manner. The tooth segment may in a modification of the embodiment also be a linear or a curved toothed rod.

The drive device 20 has a manually drivable pinion 25 which is in toothed engagement with the tooth arrangement 95 of the tooth segment 90. The drive device 20 is screwed to the associated seat frame side portion 100 by means of a plurality of screws 30. Such a drive device is known, for example, from DE 10 2009 014 651 A1. In a modification of the embodiment, the pinion 25 is an integral component of an electromotive drive device, as known, for example, from DE 197 09 852 A1.

If the drive device 20 is driven, it pivots the two associated gear members, in this instance the seat frame side portion 100 and the rear rocker arm 9, relative to each other so that, via the height adjustment kinematic 5, the height of the seat cushion 12 and the backrest 14 is changed.

The drive device 20 comprises a housing 22 which is arranged substantially at the side of the seat frame side portion 100 remote from the seat center. A part-region of the housing 22, which part-region is circular in this instance and surrounds an output shaft of the drive device 20 connected to the pinion 25, extends through a similarly circular opening 105 of the seat frame side portion 100 so that the pinion 25 is arranged at the side of the seat frame side portion 100 facing the seat center. The diameter of the opening 105 is slightly larger than the diameter of the portion of the housing 22 which extends through the opening 105. Individual component tolerances and positional tolerances can thereby be compensated for during the assembly of the drive device 20 on the seat frame side portion 100 and prior to the screws 30 being tightened so that the pinion tooth arrangement of the pinion 25 engages in a play-free manner in the tooth arrangement 95 of the tooth segment 90.

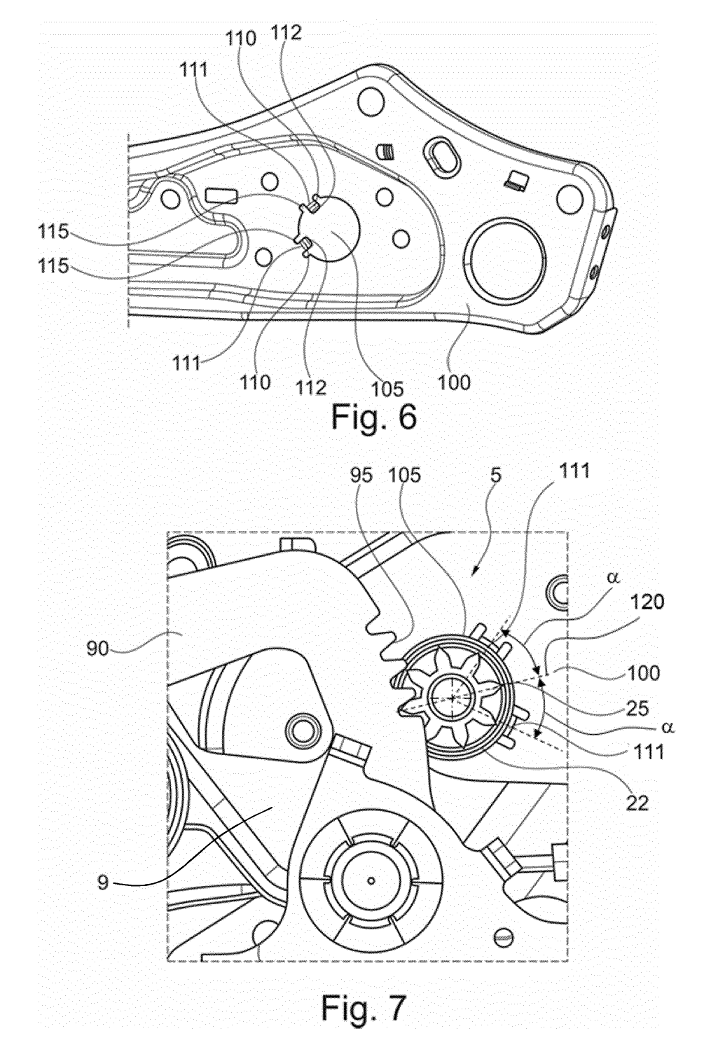

FIGS. 5 to 7 illustrate a first embodiment of a vehicle seat 1 according to the invention which corresponds to the above-described prior art with the exception of the inventively significant differences described below.

Two flaps 110, in particular of the material of the seat frame side portion 100, are constructed along the periphery of the opening 105. The flaps 110 interrupt a circular contour path of the periphery of the opening 105 and protrude slightly beyond the remaining contour path radially inward, that is to say, in the direction of the center of the opening 105.

Each of the two flaps 110 comprises a first flap portion 111 and a second flap portion 112. The first flap portion 111 is connected in the region of a cutout 115 to the material of the seat frame side portion 100 surrounding the opening 105 and extends from there substantially parallel with the seat frame side portion 100 and in the direction of the center of the opening 105. The first flap portions 111 each extend at an angle a, preferably at an acute angle α, relative to a straight connection line 120 between the rotation axis of the pinion 25 and the toothed engagement between the pinion 25 and the tooth arrangement 95. In this instance, the angle a is approximately 40°.

At the end regions of the first flap portions 111 facing in the direction of the center of the opening 105, each of the first flap portions 111 merges into a second flap portion 112. The second flap portion 112 is angled with respect to the first flap portion 111 and extends inside a notional circular cylinder which is defined by the substantially circular contour path of the periphery of the opening 105. The second flap portion 112 extends in the direction of the seat center. In this instance, the second flap portion 112 and the first flap portion 111 together define an angle of approximately 90°. A transition region between the first flap portion 111 and the second flap portion 112 is in this instance defined by a bending radius. However, the first flap portion 111 may also merge into the second flap portion 112 in a sharp-edged manner.

The flaps 110 are resilient and act as resilient means on the portion of the housing 22 which extends through the opening 105. The flaps 110 which are constructed as resilient means act on the drive device 20 in the direction of the toothed engagement by the flaps 110 flexing slightly in a radially outward direction when the housing 22 is inserted into the opening 105. The flaps 110 are distributed over the periphery of the opening 105 in such a manner that the flaps 110 act on the housing 22 with a resultant resilient force which acts in the direction of the tooth arrangement 95.

During the further assembly of the drive device 20 on the seat frame side portion 100, the resultant resilient force applied to the housing 22 by the flaps 110 moves the drive device 20 in the direction of the tooth arrangement 95 until the pinion 25 engages in the tooth arrangement 95 in a play-free manner. This relative position between the drive device 20 and the seat frame side portion 100 is secured by tightening the screws 30. In this manner, the previously mentioned tolerances are compensated for and a substantially play-free and therefore low-noise drive of the height adjustment kinematic 5 is provided.

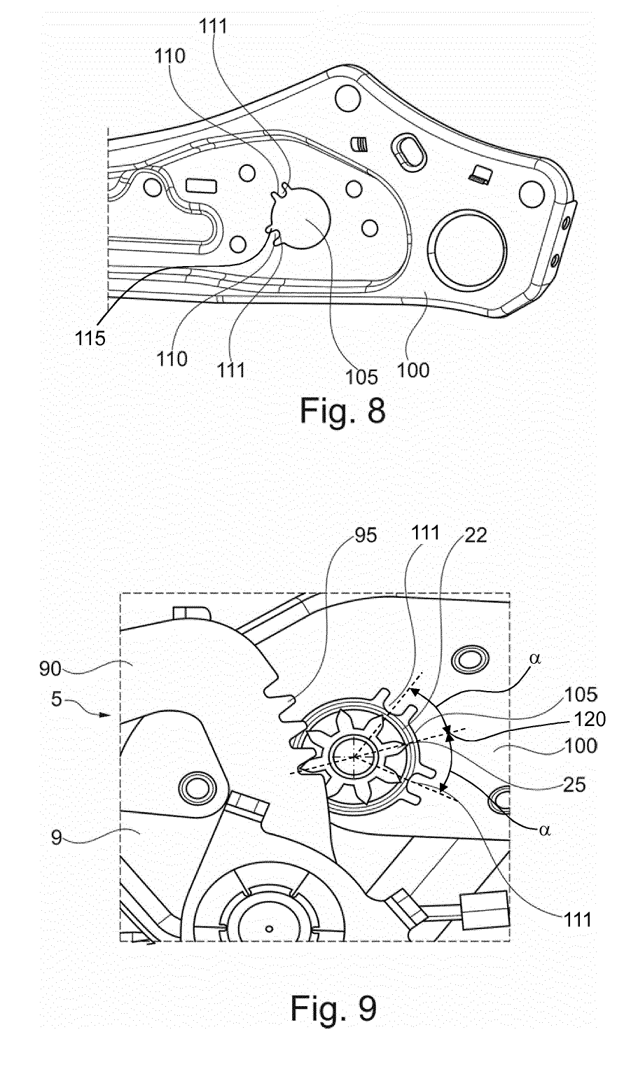

FIGS. 8 and 9 illustrate a second embodiment of a vehicle seat 1 according to the invention which corresponds to the first embodiment described above with the exception of the differences described below.

In the second embodiment, the flaps 110 each have prior to assembly, that is to say, before the housing 22 is introduced into the opening 105, only one first flap portion 111 which extends in the direction of the center of the opening 105 and which protrudes in this direction into the opening 105, more specifically protrudes into the notional circular cylinder of the opening 105. During the introduction of the housing 22 into the opening 105, the first flap portions 111 are resiliently and plastically deformed so that an initially radially inwardly facing portion of the first flap portion 111 is bent in the introduction direction of the housing 22 by the housing 22 in the direction of the seat center. The bent regions of the flap portion 111 act counter to a disassembly direction of the housing 22 out of the opening 105 in the manner of barbs. A high degree of friction thereby acts between the ends of the flap portions 111 and the housing 22 counter to the disassembly direction of the housing 22 out of the opening 105. This high level of friction brings about during the assembly an additional axial securing of the housing 22 in the opening 105 so that undesirable discharge of the housing 22 from the opening 105 is prevented even before the screws 30 are turned and tightened.

During the assembly of the drive device 20 on the seat frame side portion 100, the resultant resilient force applied to the housing 22 by the flaps 110 moves the drive device 20 in the direction of the tooth arrangement 95 until the pinion 25 engages in the tooth arrangement 95 in a play-free manner. This relative position between the drive device 20 and the seat frame side portion 100 is secured by tightening the screws 30. In this manner, as in the first embodiment, the tolerances are compensated for and a substantially play-free and thereby low-noise drive of the height adjustment kinematic 5 is provided.

The features disclosed in the above description, claims and the drawings may be significant both individually and in combination for the implementation of the invention in its various embodiments.

While specific embodiments of the invention have been shown and described in detail to illustrate the application of the principles of the invention, it will be understood that the invention may be embodied otherwise without departing from such principles.

1. A vehicle seat comprising:
a structural component;
a drive device comprising:
a tooth arrangement of an adjustment kinematic of the vehicle seat; and
a pinion in toothed engagement with the tooth arrangement in a direction of the toothed engagement, wherein the drive device is secured to the structural component of the vehicle seat; and
at least one resilient means for acting on the drive device in the direction of the toothed engagement with a force.

2. The vehicle seat as claimed in claim 1, wherein the drive device drives a height adjustment kinematic of the vehicle seat.

3. The vehicle seat as claimed in claim 1, wherein the at least one resilient means is secured to the structural component.

4. The vehicle seat as claimed in claim 1, wherein the at least one resilient means is constructed integrally with the structural component.

5. The vehicle seat as claimed in claim 1, wherein the at least one resilient means is constructed from sheet metal.

6. The vehicle seat as claimed in claim 1, wherein the at least one resilient means is constructed from sheet steel.

7. The vehicle seat as claimed in claim 1, wherein the at least one resilient means is a flap.

8. The vehicle seat as claimed in claim 1, wherein the structural component is a seat frame side portion of a seat frame of the vehicle seat.

9. The vehicle seat as claimed in claim 1, wherein precisely two resilient means act on the drive device

10. The vehicle seat as claimed in claim 1, 9, wherein the at least one resilient means acts on a housing of the drive device with a resultant resilient force which acts in the direction of the tooth arrangement.

11. The vehicle seat as claimed in claim 1, r wherein the drive device comprises a housing and a portion of the housing extends through an opening in the structural component.

12. The vehicle seat as claimed in claim 11, wherein dimensions of the opening and the portion of the housing which extends through the opening are adapted to each other in such that the drive device can be moved in the direction of the toothed engagement before the drive device is fixed to the structural component.

13. The vehicle seat as claimed in claim 12, wherein the at least one resilient means is constructed as a flap which extends from an edge region of the opening in a direction of a center of the opening, which abuts the housing and which acts on the housing with a force.

14. A method for play-free connection of a drive device to a structural component of a vehicle seat, wherein the drive device comprises a pinion which is in toothed engagement with a tooth arrangement of an adjustment kinematic of the vehicle seat, that the method comprising the steps of:
acting on the drive device with a force by means of at least one resilient means in the direction of the toothed engagement in such that any potential play between the pinion and the tooth arrangement is eliminated; and
securing a position of the drive device relative to the structural component.

15. The method as claimed in claim 14, wherein the position of the drive device relative to the structural component is secured by means of at least one screw connection during said step of acting on the drive device.

16. The method as claimed in claim 15, wherein the drive device drives a height adjustment kinematic of the vehicle seat.

17. The method as claimed in claim 15, wherein the at least one resilient means fixed to the structural component.

18. The method as claimed in claim 17, wherein the structural component is a seat frame side portion of a seat frame of the vehicle seat.

19. The method as claimed in claim 17, wherein:
the drive device comprises a housing and a portion of the housing extends through an opening in the structural component;
the at least one resilient means acts on the housing of the drive device with a resultant resilient force which acts in the direction of the tooth arrangement;
the portion of the housing which extends through the opening are adapted to each other in such a manner that the drive device is moved in the direction of the toothed engagement before the drive device is fixed to the structural component.

20. The method as claimed in claim 19, wherein the at least one resilient means is constructed as a flap which extends from an edge region of the opening in a direction of a center of the opening, which abuts the housing and which acts on the housing with a force.
